(19) United States
(12) Patent Application Publication
(10) Pub. No.: US 2025/0075067 A1
(43) Pub. Date: Mar. 6, 2025

(54) RESIN COMPOSITION

(71) Applicant: NAN YA PLASTICS CORPORATION, Taipei (TW)

(72) Inventors: Te-Chao Liao, Taipei (TW); Wei-Ru Huang, Taipei (TW); Hung-Yi Chang, Taipei (TW); Chia-Lin Liu, Taipei (TW)

(73) Assignee: NAN YA PLASTICS CORPORATION, Taipei (TW)

(21) Appl. No.: 18/481,241

(22) Filed: Oct. 5, 2023

(30) Foreign Application Priority Data
Sep. 4, 2023 (TW) 112133426

(51) Int. Cl. C08L 35/00; C08J 5/24; C08K 13/02

(52) U.S. Cl. CPC C08L 35/00; C08J 5/244; C08J 5/249; C08K 13/02; C08K 3/36; C08K 5/523; C08K 5/5425; C08K 2201/014; C08L 2201/02; C08L 2205/025; C08L 2205/035

(57) ABSTRACT

Disclosed is a resin composition including a resin. The resin includes a benzoxazine resin, an epoxy resin, and a modified maleimide resin. The modified maleimide resin is formed from a dicyclopentadiene (DCPD)-based resin having an amino group and a maleic anhydride by a condensation polymerization. The dicyclopentadiene-based resin having an amino group is formed by performing a nitration and a hydrogenation to a dicyclopentadiene phenolic resin.

### CROSS-REFERENCE TO RELATED APPLICATION

This application claims the priority benefit of Taiwan application serial no. 112133426, filed on Sep. 4, 2023. The entirety of the above-mentioned patent application is hereby incorporated by reference herein and made a part of this specification.

### BACKGROUND

### Technical Field

The present disclosure relates to a resin composition.

### Description of Related Art

In recent years, as 5G communication technology continues to develop, there are increased requirements for the reliability and electrical performance of electronic substrates such as printed circuit boards. Therefore, it is one of the goals to be attained by practitioners in the art to develop a resin composition that is able to satisfy the short circuit tests (such as CAF (Conductive Anodic Filament) test), low water absorption and low dielectric properties, and to make the electronic substrates manufactured from the resin composition to have a competitive edge.

### SUMMARY

The present disclosure provides a resin composition that is able to meet all of the requirements, including satisfying short circuit tests, low water absorption and low dielectric properties. Therefore, such resin composition has a competitive edge.

A resin composition includes a resin. The resin includes a benzoxazine resin, an epoxy resin, and a modified maleimide resin. The modified maleimide resin is formed from a dicyclopentadiene (DCPD)-based resin having an amino group and a maleic anhydride by a condensation polymerization. The dicyclopentadiene-based resin having an amino group is formed by performing a nitration and a hydrogenation to a dicyclopentadiene phenolic resin.

In an embodiment of the present disclosure, the above-mentioned modified maleimide resin has a structural formula as follows:

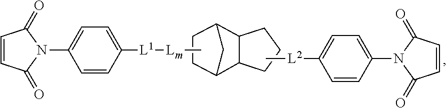

wherein L represents a dicyclopentadienyl group, a divalent organic group derived from a phenolic compound, or a combination thereof, L¹ and L² each represents a divalent organic group derived from a phenolic compound, and m represents an integer from 0 to 18.

In an embodiment of the present disclosure, a weight ratio of the modified maleimide resin to a total weight of a resin in the resin composition ranges from 40 wt % to 80 wt %.

In an embodiment of the present disclosure, a weight ratio of the benzoxazine resin to a total weight of a resin in the resin composition ranges from 10 wt % to 30 wt %.

In an embodiment of the present disclosure, a weight ratio of the epoxy resin to a total weight of a resin in the resin composition ranges from 5 wt % to 20 wt %.

In an embodiment of the present disclosure, the resin composition further includes the catalyst, flame retardant, silicon dioxide, siloxane coupling agent or a combination thereof.

In an embodiment of the present disclosure, an amount of the catalyst used is between 0.05 phr and 2 phr.

In an embodiment of the present disclosure, an amount of the flame retardant used is between 10 phr and 30 phr.

In an embodiment of the present disclosure, a weight ratio of the silicon dioxide used is between 30 wt % and 50 wt %.

In an embodiment of the present disclosure, an amount of the siloxane coupling agent used is between 0.1 phr and 5 phr.

Based on the above, the resin composition of the present disclosure is formed by selecting bismaleimide (BMI) resin that has excellent performance in short circuit tests as the main structural system. Moreover, in order to achieve good dielectric properties and water absorption, the resin composition of the disclosure further modifies the molecular structure of the maleimide resin to obtain a modified maleimide resin whose main chain includes a dicyclopentadiene structure, and the modified maleimide resin is combined with other resins (such as benzox oxazine resin, epoxy resin). In this way, it is possible to meet all of the requirements, including satisfying short circuit tests, low water absorption and low dielectric properties, so that the resin composition has a competitive edge.

In order to make the above-mentioned features and advantages of the present disclosure more clear and easy to understand, the following embodiments are specifically described in detail as follows.

### DESCRIPTION OF THE EMBODIMENTS

Embodiments of the present disclosure will be described in detail below. However, these embodiments are illustrative, and the present disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

In the disclosure, the “bivalent organic group” is an organic group with two bonding positions, and the “bivalent organic group” may form two chemical bonds via these two bonding positions.

In this embodiment, the resin composition includes a resin, wherein the resin includes benzoxazine resin, epoxy resin, and modified maleimide resin. In addition, the modified maleimide resin is formed from a dicyclopentadiene-based resin having an amino group and a maleic anhydride by a condensation polymerization, and the dicyclopentadiene-based resin having an amino group is formed by performing a nitration and a hydrogenation to a dicyclopentadiene phenolic resin. Based on the above, the resin composition of the present disclosure is formed by selecting bismaleimide (BMI) resin that has excellent performance in short circuit tests as the main structural system. Moreover, in order to achieve good dielectric properties and water absorption, the resin composition of the disclosure further modifies the molecular structure of the maleimide resin to obtain a modified dicyclopentadiene bismaleimide (DCPD-BMI) whose main chain includes a dicyclopentadiene structure, and the modified maleimide resin is combined with other resins (such as benzox oxazine resin, epoxy resin). In this way, it is possible to meet all of the requirements, including satisfying short circuit tests, low water absorption and low dielectric properties, so that the resin composition has a competitive edge.

Furthermore, through the selection and modification of the resin of the present disclosure, a synergistic effect will be generated in the molecular structure of these resins. In this way, in current applications (such as low-dielectric copper-clad laminates), it is possible to avoid poor performance in short circuit tests when using polyphenylene ether (PPE) as the main structural system. In the meantime, it is also attainable to effectively improve the reliability performance of unmodified maleimide resin. For example, the glass transition temperature of the substrate made of the resin composition of the present disclosure is greater than 220° C., the dielectric constant (Dk) is between 3.3 and 3.7, and the dielectric loss (Df) is less than 0.004, but the present disclosure is not limited thereto.

In some embodiments, the resin composition may not include polyphenylene ether resin, so as to further reduce the adverse effects of polyphenylene ether resin on the short circuit test, but the disclosure is not limited thereto.

The specific details of modified maleimide resin, benzoxazine resin and epoxy resin will be described in detail below.

### Modified Maleimide Resin

In some embodiments, specific examples of commercially available dicyclopentadiene resins having phenolic groups may include ERM6140 (trade name; manufactured by SONGWON Co., Ltd.; weight average molecular weight: 1,300), ERM6105 (trade name; manufactured by SONGWON Co., Ltd.; weight average molecular weight: 800), ERM6115 (trade name; manufactured by SONGWON Co., Ltd.; weight average molecular weight: 1,100) or other suitable dicyclopentadiene phenolic resins.

In some embodiments, the weight ratio of the modified maleimide resin to the resin ranges from 40 wt % to 80 wt %, but the disclosure is not limited thereto.

### Preparation Method of Modified Maleimide Resin

First, the dicyclopentadiene phenolic resin was subjected to a nitration reaction and a hydrogenation reaction to form a dicyclopentadiene-based resin having an amino group. The method of performing nitration and hydrogenation reactions to the dicyclopentadiene phenolic resin is not particularly limited in the disclosure. For example, commonly known nitration and hydrogenation methods may be adopted, which will not be described in details here. Next, the dicyclopentadiene-based resin having an amino group and maleic anhydride were subjected to a condensation polymerization reaction to form a modified maleimide resin. In this embodiment, the equivalent ratio of the molar number of the amino group of the dicyclopentadiene-based resin having an amino group to the molar number of the maleic anhydride group of the maleic anhydride is 1:1 to 1:10, preferably 1:1 to 1:3.

Modified maleimide resin has a structure represented by the following formula (1). In this embodiment, the weight average molecular weight of the modified maleimide resin is 800 to 10,000, preferably 1,000 to 4,000.

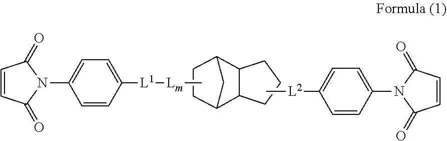

In formula (1), L represents a dicyclopentadienyl group, a divalent organic group derived from a phenolic compound, or a combination thereof, preferably a combination of a dicyclopentadienyl group and a divalent organic groups derived from a phenolic compound, and the divalent organic group is preferably a divalent organic group including a maleimide group; L¹ and L² each represents a divalent organic group derived from a phenolic compound; and m represents an integer from 0 to 18, preferably 2 to 10.

L, L¹ and L² may represent a divalent organic group derived from phenol. In this embodiment, L may represent

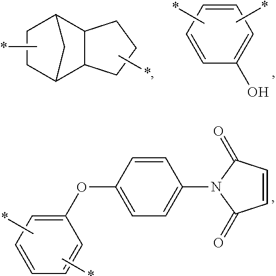

or a combination thereof, preferably a combination of

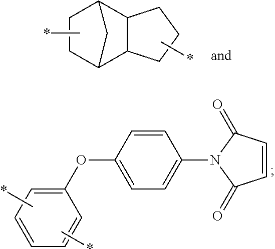

* represents a bonding position. L¹ and L² each may represent

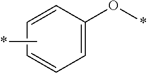

respectively; * represents the bonding position.

In this embodiment, the modified maleimide resin may have a structure represented by the following formula (2). In this embodiment, the modified maleimide resin is a modified multi-maleimide resin.

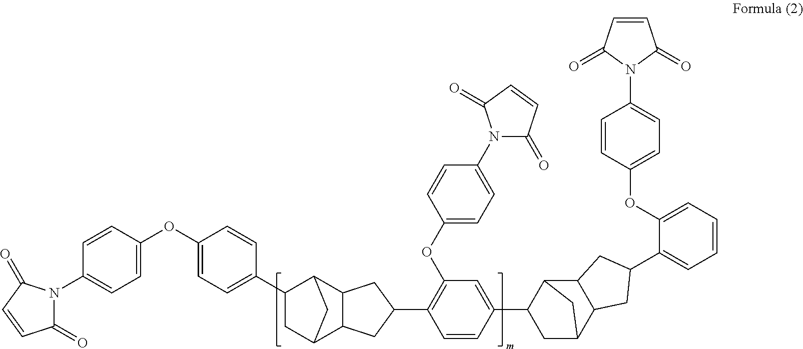

In formula (2), m represents an integer from 0 to 18, preferably from 2 to 10.

### Benzoxazine Resin and Epoxy Resin

In some embodiments, the benzoxazine resin may be any suitable commercially available BZ resin, which is not limited by the present disclosure. Epoxy resins may be classified into various types of epoxy resins according to different main skeletons. For example, the various types of epoxy resins may be classified into: bisphenol type epoxy resin, such as bisphenol type A epoxy resin, bisphenol F type epoxy resin, bisphenol S type epoxy resin, etc.; novolac type epoxy resin, such as biphenyl aralkyl novolak type epoxy resin, phenol novolak type epoxy resin, alkylphenol novolac type epoxy resin, cresol novolak type epoxy resin, naphthol alkylphenol copolymerized novolak type epoxy resin, naphthol aralkyl cresol copolymerized novolac type epoxy resin, bisphenol A novolac type epoxy resin, bisphenol F novolak epoxy resin, etc.; stilbene type epoxy resin; epoxy resin containing triazine skeleton; epoxy resin containing fennel skeleton; naphthalene type epoxy resin; anthracene type epoxy resin; triphenylmethane type epoxy resin; biphenyl type epoxy resin; xylene type epoxy resin; dicyclopentadiene epoxy resin, such as alicyclic epoxy resin, etc.

In some embodiments, a weight ratio of the benzoxazine resin to a total weight of a resin in the resin composition ranges from 10 wt % to 30 wt %, but the disclosure is not limited thereto.

In some embodiments, a weight ratio of the epoxy resin to a total weight of a resin in the resin composition ranges from 5 wt % to 20 wt %, but the disclosure is not limited thereto.

In some embodiments, only modified maleimide resin is adopted in the resin composition. In other words, the resin composition may not include unmodified maleimide resin to achieve better water absorption and dielectric properties, but the disclosure is not limited thereto. In other embodiments, according to actual application and requirements of products, the resin composition may further include unmodified maleimide resin, that is, the resin composition may simultaneously include the unmodified maleimine resin and the modified maleimine resin, wherein the unmodified maleimine resin may be commercially available products BMI-50P, KI-70 or the like, but the disclosure is not limited thereto.

In some embodiments, when the resin composition includes an unmodified maleimine resin, a weight ratio of the sum of the unmodified maleimine resin and the modified maleimine resin to a total weight of the resin in the resin composition ranges from 40 wt % to 80 wt %, but the present disclosure is not limited thereto.

In some embodiments, the resin composition further includes a catalyst, a flame retardant, silica, a siloxane coupling agent or a combination thereof, wherein an amount of the catalyst used is between 0.05 phr and 2 phr; an amount of the flame retardant used is between 10 phr and 30 phr. A weight ratio of silica to a weight of resin, flame retardant and silica in the resin composition ranges from 30 wt % to 50 wt %. An amount of siloxane coupling agent used ranges from 0.1 phr to 5 phr, but the disclosure is not limited thereto. Herein, the unit “phr” may be defined as parts by weight of other materials added per 100 parts by weight of the resin of the resin composition. The weight ratio of silicon dioxide is based on the weight of the resin of the resin composition plus the weight of the flame retardant.

In some embodiments, the catalyst may be 2-ethyl 4-methylimidazole (2E4MZ; CAS: 931-36-2;

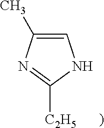

to catalyze better reaction of resin during thermal curing, but the disclosure is not limited thereto.

In some embodiments, the flame retardant is a halogen-free flame retardant and a specific example may be a phosphorus-based flame retardant. The phosphorus-based flame retardant may be selected from phosphate ester, such as triphenyl phosphate (TPP), resorcinol diphosphate (RDP), bisphenol A bis(diphenyl) phosphate (BPAPP), bisphenol A bis(dimethyl) phosphate (BBC), resorcinol diphosphate (CR-733S), resorcinol-bis(di-2,6-dimethylphenyl phosphate) (PX-200); may be selected from phosphazene, such as polybis(phenoxy)phosphazene (SPB-100); may be selected from ammonium polyphosphate, such as melamine phosphate (MPP), melamine cyanurate; may be selected from more than one combination of DOPO flame retardants, such as DOPO (such as having a structural formula (C)), DOPO-HQ (such as having a structural formula (D)), double DOPO derivative structure (such as having a structural formula (E)), etc.; may be selected from aluminum-containing hypophosphite (such as having a structural formula (F)):

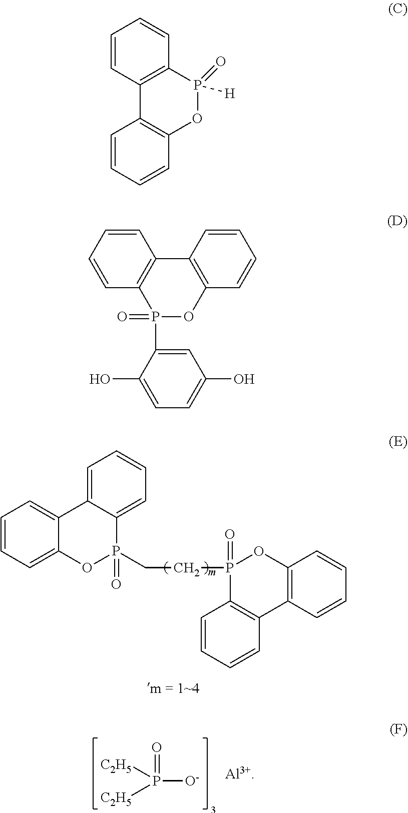

In some embodiments, the silicon dioxide (or called “silica” in some examples) is a spherical silica and may preferably be prepared using a synthetic method to reduce electrical properties and maintain fluidity and gel filling properties, wherein the spherical silica has acrylic or vinyl surface modification, the purity is above 99.0%, and the average particle diameter (D50) is about 2.0 μm to 3.0 μm, but the disclosure is not limited thereto. Other suitable methods may also be adopted to prepare silica.

In some embodiments, the siloxane coupling agents may include, for example but not limited to, siloxane compounds. In addition, according to the types of functional groups, the siloxane coupling agents may be divided into amino silane compounds, epoxy silane compounds, vinyl silane compounds, ester silane compounds, hydroxyl silane compounds, isocyanate silane compounds, methylacryloxysilane compounds and acryloxy silane compounds, for enhancing the compatibility and cross-linking degree of the glass fiber cloth and powder in the circuit board, but the disclosure is not limited thereto.

It is noted that the resin compositions of the disclosure may be processed into prepregs and copper foil substrates (or called “copper clad laminates (CCL)” in some examples) according to actual design requirements, and the specific implementations listed above are not limitations of the disclosure, as long as the resin composition system including a benzoxazine resin, an epoxy resin, and a modified maleimide resin belong to the protection scope of the disclosure.

The following examples and comparative examples are listed to illustrate the effects of the disclosure, but the protection scope of the disclosure is not limited to the examples.

The copper foil substrates in the respective examples and comparative examples were evaluated based on the following methods.

“Glass transition temperature (° C.)” is tested by using a dynamic mechanical analyzer (DMA).

“Water absorption (%)” is calculated by the weight change of the sample before and after heating the sample in a pressure cooker at 120° C. and 2 atm for 120 minutes.

“288° C. solder heat resistance (seconds)” indicates immersing the sample in a soldering furnace at 288° C. after heating the sample in a pressure cooker at 120° C. and 2 atm for 120 minutes, and recording the time required for sample explosion/delamination.

“Dielectric constant Dk” is measured by using a dielectric analyzer (model HP Agilent E4991A) to test the dielectric constant at a frequency of 10 GHz.

“Dielectric loss Df” is measured by using a dielectric analyzer (model HP Agilent E4991A) to test the dielectric loss at a frequency of 10 GHz.

CAF test: The copper foil substrate is tested under the following conditions: temperature and humidity 85° C./85% RH, voltage 50V, time>1000 hours, aperture: 0.35 mm, aperture spacing: 0.3 mm.

### Examples 1 to 3 and Comparative Examples 1 to 2>

Each resin composition shown in Table 1 was mixed with toluene to form a thermosetting resin composition varnish. The varnish was impregnated with Nanya fiberglass cloth (cloth type 1078LD from Nanya Plastics Cooperation) at room temperature. A prepreg with a resin content of 70 wt % was obtained after drying for several minutes at 130° C. (in impregnator). Finally, 4 pieces of the prepregs were stacked layer by layer between two layers of 35 μm thick copper foils. Under a pressure of 25 kg/cm² and a temperature of 85° C., a constant temperature was kept for 20 minutes. Then, after heating to 210° C. at a heating rate of 3° C./min, a constant temperature was kept again for 120 minutes. Then, the temperature was slowly cooled down to 130° C. to obtain a 0.59 mm thick copper foil substrate. Herein, the modified maleimide resin in Table 1 is formed by following steps: a dicyclopentadiene phenolic resin containing about 1 mole of hydroxyl group (trade name ERM6140, manufactured by SONGWON Co., Ltd.; weight average molecular weight: 1,300) and about 1.25 mole of 4-halogenitrobenzene (halogen may be fluorine, chlorine, bromine or iodine) were added to about 6 moles of dimethylacetamide (DMAC) as a reaction solvent, and the reaction was carried out at a temperature of about 120° C. for about 300 minutes to perform a nitration reaction. Next, hydrogen gas was introduced, and the reaction was carried out at a temperature of about 90° C. for about 480 minutes to perform a hydrogenation reaction to form a dicyclopentadiene-based resin having an amino group. Next, about 3 moles of maleic anhydride and about 9.7% by weight (wt %) of toluenesulfonic acid were added to carry out a reaction at a temperature of about 120° C. for about 420 minutes, so as to obtain the modified maleimide resin in Table 1. The modified maleimide resin is a maleimide resin whose main chain includes a dicyclopentadiene structure (i.e., homemade DCPD-MI) and has a structure represented by

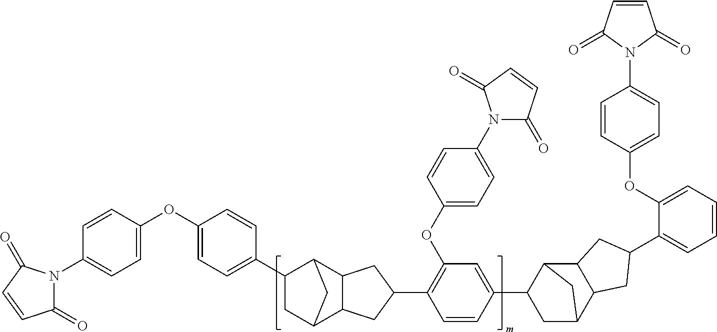

(m represents an integer from 0 to 18).

The physical properties of the copper foil substrates as prepared were tested. The results are shown in Table 1. After comparing the results of Examples 1 to 3 and Comparative Examples 1 to 2 in Table 1, the following conclusions may be drawn. Comparative Example 1 is a structural system based on polyphenylene ether, which has a poor performance in the short circuit (CAF) test and is prone to short circuit conduction problems. Comparative Example 2 only uses unmodified maleimide resin, so the performance in water absorption and dielectric properties is also poor. Examples 1 to 3 all satisfy the short circuit test and have both low water absorption and low dielectric properties.

TABLE 1

| | | Example | | | | | | Comparative Example | | | |
|---|---|---|---|---|---|---|---|---|---|---|---|
| | | 1 | | 2 | | 3 | | 1 | | 2 | |
| Resin (100 | Polyphenylene ether resin | 0 | | 0 | | 0 | | 50 | wt % | 0 | |
| parts by | (SA9000) | | | | | | | | | | |
| weight in | Unmodified maleimine | 40 | wt % | 0 | | 0 | | 0 | | 40 | wt % |
| total) | resin (BMI-50P) | | | | | | | | | | |
| | Unmodified maleimine | 0 | | 30 | wt % | 0 | | 20 | wt % | 30 | wt % |
| | resin (KI-70) | | | | | | | | | | |
| | Modified maleimine resin | 30 | wt % | 40 | wt % | 70 | wt % | 0 | | 0 | |
| | RI-100 | 0 | | 0 | | 0 | | 10 | wt % | 0 | |
| | Benzoxazine resin (KB- | 20 | wt % | 20 | wt % | 20 | wt % | 0 | | 20 | wt % |
| | 610F (KUEN BONG | | | | | | | | | | |
| | CHEMICAL)) | | | | | | | | | | |
| | Epoxy resin (BPA Epoxy) | 10 | wt % | 10 | wt % | 10 | wt % | | | 10 | wt % |
| | Cross-linking agent | 0 | | 0 | | 0 | | 20 | wt % | 0 | |
| | (TAIC) | | | | | | | | | | |
| Other | Flame retardant (PX-200 | 20 | phr | 20 | phr | 20 | phr | 20 | phr | 20 | phr |
| additives | (DAIHACHI | | | | | | | | | | |
| (relative to | CHEMICAL) | | | | | | | | | | |
| 100 parts | Silicon dioxide | 45 | wt % | 45 | wt % | 45 | wt % | 45 | wt % | 45 | wt % |
| by weight | Catalyst (Luf) | 0- | | 0- | | 0- | | 1 | phr | 0- | |
| of resin) | Catalyst (2E4MZ) | 0.5 | phr | 0.5 | phr | 0.5 | phr | 0- | | 0.5 | phr |
| | Siloxane coupling agent | 0.5 | phr | 0.5 | phr | 0.5 | phr | 0.5 | phr | 0.5 | phr |
| | (methacryloxysilane | | | | | | | | | | |
| | compound, silane) | | | | | | | | | | |

| | | | | | | | | | | |
|---|---|---|---|---|---|---|---|---|---|---|
| B-stage curing temperature | 130° | C. | 130° | C. | 130° | C. | 130° | C. | 130° | C. |
| Glass transition temperature (° C.) | 261° | C. | 249° | C. | 252° | C. | 218° | C. | 256° | C. |

| | | | | | |
|---|---|---|---|---|---|
| Water absorption (PCT ½ hour) | 0.42% | 0.39% | 0.35% | 0.22% | 0.48% |
| Heat resistance (PCT ½ hour) | Pass | Pass | Pass | Pass | Pass |
| Water absorption (PCT 2 hours) | 0.51% | 0.48% | 0.41% | 0.28% | 0.55% |
| Heat resistance (PCT 2 hours) | Pass | Pass | Pass | Pass | Pass |
| Dielectric constant (Dk)/dielectric loss | 3.65/0.0048 | 3.51/0.0045 | 3.36/0.0037 | 3.19/0.0036 | 3.8/0.0059 |
| (Df) (measurement frequency 10 GHz) | | | | | |
| CAF test | Pass | Pass | Pass | NG | NG |

Based on the above, the resin composition of the present disclosure is formed by selecting bismaleimide (BMJ) resin that has excellent performance in short circuit tests as the main structural system. Moreover, in order to achieve good dielectric properties and water absorption, the resin composition of the disclosure further modifies the molecular structure of the maleimide resin to obtain a modified maleimide resin whose main chain includes a dicyclopentadiene structure, and the modified maleimide resin is combined with other resins (such as benzox oxazine resin, epoxy resin). In this way, it is possible to meet all of the requirements, including satisfying short circuit tests, low water absorption and low dielectric properties, so that the resin composition has a competitive edge.

Although the disclosure has been disclosed in the above embodiments, the embodiments are not intended to limit the disclosure. Persons skilled in the art may make some changes and modifications without departing from the spirit and scope of the disclosure. The protection scope of the disclosure shall be defined by the appended claims.

What is claimed is:

1. A resin composition, comprising:
a resin, comprising:
a benzoxazine resin;
an epoxy resin; and
a modified maleimide resin, wherein the modified maleimide resin is formed from a dicyclopentadiene-based resin having an amino group and a maleic anhydride by a condensation polymerization, and the dicyclopentadiene-based resin having the amino group is formed by performing a nitration and a hydrogenation to a dicyclopentadiene phenolic resin.

2. The resin composition according to claim 1, wherein the modified maleimide resin has a structural formula as follows: 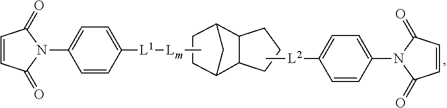
wherein L represents a dicyclopentadienyl group, a divalent organic group derived from a phenolic compound, or a combination thereof, L¹ and L² each represents a divalent organic group derived from the phenolic compound, and m represents an integer from 0 to 18.

3. The resin composition according to claim 1, wherein a weight ratio of the modified maleimide resin to a total weight of the resin in the resin composition ranges from 40 wt % to 80 wt %.

4. The resin composition according to claim 1, wherein a weight ratio of the benzoxazine resin to a total weight of the resin in the resin composition ranges from 10 wt % to 30 wt %.

5. The resin composition according to claim 1, wherein a weight ratio of the epoxy resin to a total weight of the resin in the resin composition ranges from 5 wt % to 20 wt %.

6. The resin composition according to claim 1, further comprising a catalyst, a flame retardant, a silicon dioxide, a siloxane coupling agent or a combination thereof.

7. The resin composition according to claim 6, wherein an amount of the catalyst used is between 0.05 phr and 2 phr.

8. The resin composition according to claim 6, wherein an amount of the flame retardant used is between 10 phr and 30 phr.

9. The resin composition according to claim 6, wherein a weight ratio of the silicon dioxide used is between 30 wt % and 50 wt %.

10. The resin composition according to claim 6, wherein an amount of the siloxane coupling agent used is between 0.1 phr and 5 phr.
